(19) United States
(12) Patent Application Publication
(10) Pub. No.: US 2020/0384355 A1
(43) Pub. Date: Dec. 10, 2020

(54) DEVICE FOR CONTROLLING A MOTION SYSTEM

(71) Applicant: Mitsubishi Electric Corporation, Tokyo (JP)

(72) Inventors: Andrey Valerievich GRUZDEV, Voronezh (RU); Evgenii Nikolaevich PEREVOZCHIKOV, Voronezh (RU)

(21) Appl. No.: 16/609,825

(22) PCT Filed: Apr. 26, 2018
(86) PCT No.: PCT/RU2018/000275

§ 371 Date: Dec. 18, 2019

(30) Foreign Application Priority Data
May 5, 2017 (RU) 2017116085

(51) Int. Cl. A63F 13/24; A63F 13/218; A63F 13/235; G06F 3/033

(52) U.S. Cl. CPC A63F 13/24; G06F 3/033; A63F 13/235; A63F 13/218

(57) ABSTRACT

The invention relates to input devices. The claimed device comprises buttons, and a housing rigidly coupled to a control element in the form of an H-shaped frame having curved support surfaces, wherein buttons and rollers are arranged opposite each other along the side edges of the front portions of the control element, a hinge is disposed inside the housing and has a stem rigidly attached thereto, clamps are mounted on the control element in the form of an H-shaped frame, between the curved support surfaces thereof, and a regulator which controls the rigidity of movement of the hinge is disposed inside the housing, pedals and motion sensors are connected to the control element by a wired or wireless connection, the stem is rigidly coupled to a mounting bracket having adjusting clamps, the curved support surfaces are provided with a regulator for controlling their position on the control element.

### CROSS-REFERENCE TO RELATED APPLICATIONS

The present patent application is a National stage application from PCT application PCT/RU2018/000275 filed Apr. 26, 2018 which claims priority to Russian patent application RU2017116085 filed May 5, 2017.

### FIELD OF INVENTION

The invention relates to computer technology, particularly input devices, and may be used in computer games, for controlling objects in computer-modeled spaces, and in the fields of mechanical engineering, aeronautical engineering, space technology, and underwater and surface marine transport.

### BACKGROUND

There is a known computer manipulator, disclosed in the description of a patent for a utility model No. 45843, dated Feb. 15, 2005, Int. Cl. G06 F3/033, published May 27, 2005 in Bulletin No. 15, comprising buttons and a casing in which a hinge is mounted, a stein being rigidly attached to the hinge for fastening it at any convenient place for the operator, the casing being rigidly connected to a control element made in the form of an H-shaped frame with curved support surfaces on which the operator's forearms can be placed with the possibility of movement by means of the hinge, buttons and rollers for convenient control of the motion system being placed opposite one another on the lateral sides of the front parts of the control element along its periphery.

Drawbacks: the controllable functions in the motion system are deficient in terms of quantity, quality, reliability and precision. The stein has no rigid connection to the operator's seat, and there is a lack of precise regulation of the height of the control element or precise regulation of the distance between the operator and the control element, as well as a lack of control elements for the feet or motion sensors for monitoring the position of the operator's head, hands and shoulders. The control element has no facility for regulating the H-shaped frame according to the width of the operator's shoulders, and there is no facility for regulating the stiffness of the travel of the hinge according to the operator's weight or the situation obtaining in the motion system.

The most similar of the known technical solutions is the description of an invention in Russian Federation patent no. 2556498, Device for controlling a motion system, Int. Cl. G06 F3/00, dated 7 Jan. 2014, published 7 Oct. 2015 in Bulletin no. 19, comprising buttons and a casing rigidly connected to a control element made in the form of an H-shaped frame with curved support surfaces, along the periphery of the front parts of which buttons and rollers are placed opposite one another on the lateral sides, while a hinge, to which a stein is rigidly attached, is fitted internally, clamps are fitted between the curved support surfaces on the control element made in the form of an H-shaped frame, and a regulator controlling the stiffness of the hinge movement is placed inside the casing. To control the motion system, pedals and motion sensors, connected to the control element by wires or a wireless link, are also added, and the stein is rigidly connected to a mounting bracket having regulating clamps.

Drawbacks: the controllable functions in the motion system are deficient in terms of quantity, quality, reliability and precision. The curved support surfaces do not provide for precise adjustment of the angle of positioning relative to the operator's body and the control element, or for precise distribution of the weight of the operator's forearm relative to the control element. The separate control by each hand makes it impossible to achieve high levels of quantity, quality, reliability and precision of the controllable functions in the motion system.

### SUMMARY

Technical result: higher levels of quantity, quality, reliability and precision of the controllable functions in the motion system.

In a device for controlling a motion system, comprising buttons and a casing rigidly connected to a control element made in the form of an H-shaped frame with curved support surfaces, on the front parts of which buttons and rollers are placed along the periphery opposite one another on the lateral sides, while a hinge, to which a stein is rigidly attached, is fitted internally, clamps are fitted between the curved support surfaces on the control element made in the form of an H-shaped frame, a regulator controlling the stiffness of the hinge movement is placed inside the casing, pedals and motion sensors, connected to the control element by wires or a wireless link, are added to the device for controlling a motion system, and the stein is rigidly connected to a mounting bracket having regulating clamps, the technical result is achieved by the fact that, the curved support surfaces are equipped with a regulator controlling the position of the curved support surfaces on the control element, while at least two additional control elements, connected to the control element by wires or a wireless link, are added for controlling the motion system in additional analog and mixed modes, buttons and rollers being placed on the front parts of these additional control elements along the periphery, one opposite another on the lateral sides, the shape of each additional control element possibly being made differently in terms of its volume and configuration, in a curved ergonomic shape required for a specific game or for a specific environment for the application of the device for controlling a motion system.

In the claimed device, by contrast with similar solutions, the curved support surfaces are equipped with a regulator for setting the positioning angle of the curved support surfaces relative to the operator's body and the control element as accurately as possible, thereby providing the operator with the most comfortable possible control conditions and improving the quality of his work by increasing his period of accurate, reliable and trouble-free work, the regulator also permitting the most accurate possible choice of the central support point of the curved support surfaces relative to the operator's forearms and the control element, thus enabling the operator to distribute the weight of his forearms with the greatest possible precision relative to the control element and thereby improving the reliability and levels of quantity, quality and precision of the controllable functions in the motion system during the performance of tasks.

During the operation of the claimed device, because the device is fitted with at least two additional control elements controlling the motion system in additional analog and mixed modes, the operator is able to perform control tasks by holding the additional control elements with both hands or by simultaneously holding an additional control element in one hand while the other hand is lying on the control element, performing a separate task with each hand, which increases the reliability when two different tasks have to be performed simultaneously, increases the number of tasks that can be performed simultaneously by the operator's interaction with the buttons and rollers placed on the additional control elements, reduces the total time required to perform tasks and increases the quality of the performance of tasks owing to the possibility of performing one task with two independent hands holding the additional control elements or an additional control element, by means of the operator's interaction with the buttons and rollers placed on the additional control elements, enabling the operator to use functions from a conventional mode in analog mode.

Because of the presence of significant characteristics distinct from the prototype, the claimed technical solution can be recognized as novel.

The prior art does not disclose technical solutions having characteristics identical with the distinctive characteristics of the claimed device, and consequently the claimed device meets the criterion of inventive step.

The possibility of applying the claimed invention in industry enables it to be recognized as meeting the criterion of industrial applicability.

### BRIEF DESCRIPTION OF THE DRAWINGS

The device for controlling a motion system is explained with the aid of the drawing, in which:

FIG. 1 shows a general view of the device;

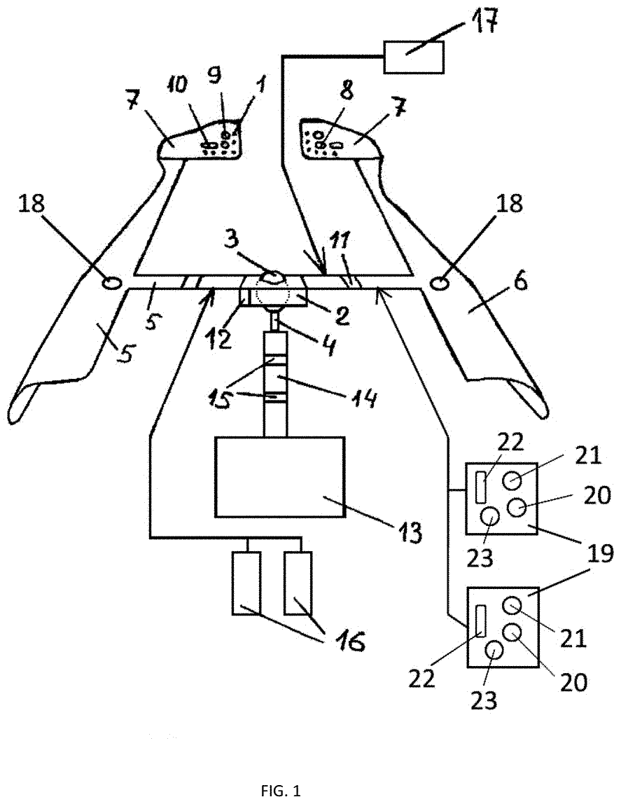

FIG. 2 shows schematically the operation of the device in conventional, analog and mixed modes, in which each control element is made in the form of a pistol grip.

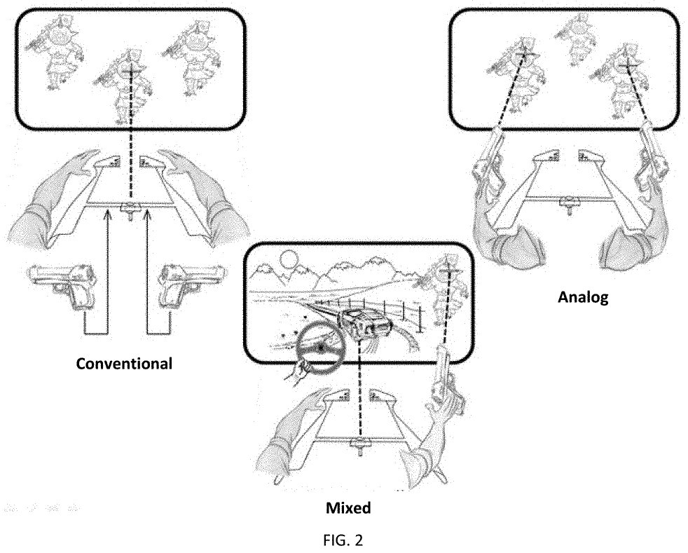

### DETAILED DESCRIPTION OF THE PREFERRED EMBODIMENT

The device for controlling a motion system comprises buttons 1 and a casing 2, in which casing 2 there is fitted a hinge 3, to which is rigidly attached a stein 4 rigidly connected to the operator's seat 13 by a bracket 14 with clamps 15, the casing 2 being rigidly connected to a control element 5 made in the form of an H-shaped frame with curved support surfaces 6 on which the operator's forearms can be placed with the possibility of movement by means of the hinge 3, the stiffness of the movement of which may be regulated, with the aid of a regulator 12 placed in the casing 2, as required by the operator, or automatically in accordance with the situation obtaining in the motion system. Buttons 1, hinged buttons 8, multi-contact buttons 9, and rollers 10 for the reliable and precise control of the motion system are placed opposite one another on lateral sides along the periphery of the front parts 7 of the control element 5, the control element 5 being capable of regulating the H-shaped frame by means of clamps 11 placed along the width of the frame between the curved support surfaces 6. The curved support surfaces 6 are equipped with a regulator 18 controlling the position of the curved support surfaces 6 on the control element 5. The device for controlling a motion system is equipped with pedals 16 and motion sensors 17, connected to the control element 5 by wires or by a wireless link, for providing additional control of the motion system using at least two additional control elements 19, controlling the motion system in additional analog and mixed modes, which are connected to the control element 5 by wires or by a wireless link. Buttons 20, multi-contact buttons 21, hinged buttons 23 and rollers 22 are placed opposite one another on the lateral sides along the periphery of the front parts of said elements 19. The shape of each additional control element 19 may be different in terms of volume and configuration, may be made in the form of a pistol grip or another kind of weapon, in a curved ergonomic shape required for a specific game or a curved ergonomic shape required for a specific application environment.

Operation of the Device:

The device for controlling a motion system operates in the following manner. Using the bracket 14 with the clamps 15, the operator selects the support point of the control element 5 with the greatest possible precision, and rigidly attaches on it the stein 4 which is rigidly connected to the hinge 3. The operator sits on the seat 13 in front of the casing 2, and his forearms rest on the control element 5 made in the form of an H-shaped frame with curved support surfaces 6 on which the operator's forearms can be placed with the possibility of movement by means of the hinge 3, the drawing is shifted to a separate sheet, rigidly attached to the seat 13 by means of the stein 4 and bracket 14 with the clamps 15. The operator sets the precise width of the control element 5 for himself, using the clamps 11, sets the precise positioning angle of the curved support surfaces 6 for himself relative to his body and the control element 5, using the regulator 18, and sets the precise positioning point of the curved support surfaces 6 for himself relative to his forearms and the control element 5, using the regulator 18. The control element 5 is rigidly connected to the casing 2 in which is placed the hinge 3, by means of which the control element 5 is enabled to move, a regulator 12 being fitted in the casing 2 and controlling the stiffness of movement of the hinge 3, and before starting work the operator sets the requisite degree of stiffness of movement of the hinge 3, using the regulator 12. The motion system is partially controlled by the operator's forearms lying on the curved support surfaces 6, partially controlled by the operator's hands lying on the front parts 7 of the control element 5, partially controlled by the operator's feet using the pedals 16, partially controlled by movements of the operator's head, hands and shoulders using the motion sensors 17, and partially controlled by the operator's hands holding the additional control elements 19. Since the regulator 12 placed in the casing 2 automatically controls the stiffness of movement of the hinge 3 in the casing 2 during the operation of the manipulator according to the situation in the motion system, the operator experiences a “feedback” effect and a more precise perception of the motion system, and in the mixed control mode the regulator 12 maintains free movement in only one axis of rotation, converting the control element 5 so that it resembles an automobile steering wheel. Since a part of the motion system is controlled by the operator's feet using the pedals 16, the operator is more deeply immersed in the space modeled on the electronic computer (referred to hereafter as the computer), and experiences an effect of “being inside” the space modeled on the computer. Since a part of the motion system is controlled by movements of the operator's head, hands and shoulders using the motion sensors 17, the operator is provided with new functions in the motion system. Since a part of the motion system is controlled by the operator's hands holding the additional control elements 19, the operator is enabled to perform control tasks with two hands in analog and mixed modes, to work on different tasks in parallel, or to perform one task with two hands, the operator's fingers interacting with the buttons 1, the hinged buttons 8, the multi-contact buttons 9 and the rollers 10 placed on the front parts 7 of the control element 5 along the periphery opposite one another on the lateral sides for precise control of the motion system, the operator's fingers also interacting with buttons 20 of the additional control element 19, multi-contact buttons 21 of the additional control element 19, hinged buttons 23 of the additional control element 19, and rollers 22 of the additional control element 19 placed on the front parts of at least two supplementary additional control elements 19 along the periphery opposite one another on the lateral sides for precise control of the motion system.

### Example 1

Using the bracket 14 with the clamps 15, the operator selects the support point of the control element 5 with the greatest precision, and rigidly attaches it to the stein 4 which is rigidly connected to the hinge 3. The operator sits on the seat 13 in front of the casing 2, and his forearms rest on the control element 5 made in the form of an H-shaped frame with the curved support surfaces 6 on which the operator's forearms can be placed with the possibility of movement by means of the hinge 3 rigidly attached to the seat 13 by means of the stein 4 and the bracket 14 with the clamps 15. The operator sets the precise width of the control element 5 for himself, using the clamps 11, sets the precise positioning angle of the curved support surfaces 6 for himself relative to his body and the control element 5, using the regulator 18, and sets the precise positioning point of the curved support surfaces 6 for himself relative to his forearms and the control element 5, using the regulator 18.

Before starting work, the operator sets the requisite degree of stiffness of movement of the hinge 3, using the regulator 12. The motion system is partially controlled by the operator's forearms lying on the curved support surfaces 6, partially controlled by the operator's hands lying on the front parts 7 of the control element 5, partially controlled by the operator's feet using the pedals 16, partially controlled by movements of the operator's head, hands and shoulders using the motion sensors 17, and partially controlled by the operator's hands holding the additional control elements 19. Since the regulator 12 placed in the casing 2 automatically controls the stiffness of movement of the hinge 3 in the casing 2 according to the situation in the motion system during the operation of the manipulator, the operator experiences a “feedback” effect and a more precise perception of the motion system. Since part of the motion system is controlled by the operator's feet using the pedals 16, the operator is more deeply immersed in the space modeled on the computer, and experiences an effect of “being inside” the space modeled on the computer. The operator controls functions relating to the feet, such as “walk and run, forward-backward” or moving a vehicle “forward-backward”, by means of his feet, using the pedals 16. Since part of the motion system is controlled by movements of the head, hands and shoulders using the motion sensors 17, the operator is provided with new functions in the motion system. One of the new functions in the motion system is the capability of “looking round a corner” without moving the body of the controlled object: the operator himself moves to one side, and the motion sensors 17, controlling the position of the head, hands and shoulders, create this effect in the space modeled on the computer. Since part of the motion system is controlled by the operator's hands holding the additional control elements 19, the operator is able to perform control tasks with both hands in analog and mixed modes, to work in parallel on different tasks, or to perform one task with both hands holding the additional control elements 19; a new function is the possibility of “shooting” immediately at two different targets simultaneously while performing other functions using the interaction of the operator's fingers with the buttons 20 of the additional control element 19, the multi-contact buttons 21 of the additional control element 19, the rollers 22 of the additional control element 19, and the hinged buttons 23 of the additional control element 19, or, in a mixed mode, “driving a car” with one hand and “shooting” with the other, the operator himself deciding in which mode the motion system is to be controlled, the operator still being able to use various functions of the conventional mode when in the analog mode, by means of the interaction of the operator's fingers with the buttons 20 of the additional control element 19, the multi-contact buttons 21 of the additional control element 19, the rollers 22 of the additional control element 19, and the hinged buttons 23 of the additional control element 19.

For example, when controlling a pilotless aircraft, the operator may fly to the required object in conventional mode, stop in front of the object at the requisite height and distance, and then, switching to the analog mode, start to perform the specified task with both hands, the control elements possibly having the curved ergonomic shape required for the specific application environment of the device for controlling a motion system. The operator's fingers interact with buttons 1, hinged buttons 8, multi-contact buttons 9 and rollers 10 placed on the front parts 7 of the control element 5 and along the periphery opposite one another on the lateral sides of the front part 7 for reliable, precise control of the motion system, and the operator's fingers also interact with buttons 20 of the additional control element 19, multi-contact buttons 21 of the additional control element 19, hinged buttons 23 of the additional control element 19, and rollers 22 of the additional control element 19, placed on the front parts of at least two supplementary additional control elements 19 along the periphery opposite one another on the lateral sides for reliable, precise control of the motion system.

Technical and Economic Characteristics

By using the claimed device, it will be possible to raise the levels of quantity, quality, reliability and precision of the controllable functions in the motion system.

What is claimed is:

1. A device for controlling a motion system, comprising: buttons and a casing rigidly connected to a control element made in a form of an H-shaped frame with curved support surfaces, on front parts of which the buttons and rollers are placed along a periphery opposite one another on lateral sides, while a hinge, to which a stein is rigidly attached, is fitted internally, clamps are fitted between the curved support surfaces on the control element made in the form of the H-shaped frame, a regulator controlling a stiffness of a hinge movement is placed inside the casing, pedals and motion sensors, connected to the control element by wires or a wireless link, are added to the device for controlling the motion system, and the stein is rigidly connected to a mounting bracket having regulating clamps, wherein the curved support surfaces are equipped with a regulator controlling a position of the curved support surfaces on the control element, while at least two additional control elements, connected to the control element by wires or a wireless link, are added for controlling the motion system in additional analog and mixed modes, the buttons and the rollers being placed on the front parts of these additional control elements along the periphery, one opposite another on the lateral sides, the shape of each additional control element possibly being made differently in terms of its volume and configuration, in a curved ergonomic shape required for a specific game or for a specific environment for an application of the device for controlling the motion system.
